(19) United States
(12) Patent Application Publication
(10) Pub. No.: US 2007/0258723 A1
(43) Pub. Date: Nov. 8, 2007

(54) Image forming apparatus and operating method

(76) Inventors: Yasushi Nakazato, Tokyo (JP); Shintaroh Takahashi, Kanagawa (JP); Takenori Oku, Saitama (JP); Jun Yamane, Kanagawa (JP); Osamu Satoh, Kanagawa (JP); Hitoshi Shimizu, Kanagawa (JP); Shuji Hirai, Tokyo (JP); Masahide Yamashita, Tokyo (JP)

Correspondence Address: MORRISON & FOERSTER LLP, 1650 TYSONS BOULEVARD, SUITE 400, MCLEAN, VA, 22102, US

(21) Appl. No.: 11/797,359

(22) Filed: May 2, 2007

(30) Foreign Application Priority Data
May 2, 2006 (JP) 2006-128498

(51) Int. Cl. G03G 15/00

(52) U.S. Cl. 399/9; 399/10

(57) ABSTRACT

An image forming apparatus effectively reduces its maintenance cost and prevents a failure of the image forming apparatus in a period of busy use by the user, which includes a failure prediction distinction device configured to predict a failure based on an internal state signal, a maintenance time determination device configured to determine a time when maintenance is needed based on the internal state signal, and a maintenance need distinction device configured to distinguish whether or not maintenance is needed based on a result from the failure prediction distinction device at the maintenance time determined by the maintenance time determination device.

### PRIORITY STATEMENT

The present patent application claims priority under 35 U.S.C. §119 from Japanese patent application No. 2006-128498, filed in the Japan Patent Office on May 2, 2006, the content and disclosure of which is hereby incorporated by reference herein in its entirety.

### BACKGROUND

1. Field

Exemplary embodiments generally relate to an image forming apparatus such as printers, copying machines, facsimiles, etc. Further, exemplary embodiments also relate to a method of failure prediction by detecting image quality abnormalities.

2. Background Discussion

Image forming devices using electrophotographic processes need maintenance such as, for example, the replacement of consumable articles like toner or a photoconductor, a repair at the time of failure, etc. At the time of failure of an image forming apparatus, since all or part of the functions of the image forming apparatus must stop during the time from the occurrence of the failure to the completion of repair, the time loss due to maintenance is very big for a user.

Therefore, there is a desire to reduce waiting time due to failure by predicting when the probability of failure may increase and maintaining the image forming apparatus before such failure occurs.

Various measures, as described below, have been proposed for such problems. For example, since the life of a copying machine is related to the durable life of the complete parts of the machine, the diagnoses of the quality of the operating state of each drive element has been proposed.

In another example, the total number of times of use of the image formation unit (e.g., a copying machine) over fixed periods of time is calculated. The life of the unit is predicted based on the rate of increase of the number of times of use. When the number reaches a predetermined value (for example, 1,000) below a predicted value, the image forming apparatus can display an alarm message.

In another example, individual system failures may be diagnosed one-by-one, for example, conveyance system failure, image system failure, system failure of operation, allophone system failure, input/operation system failure, etc. As a result, the occurrence of only one error transmits information required to check the terminal equipment at a service base. Such management service system has also been proposed.

A method in which a toner image is detected, the image is checked for abnormality and regular recording operation is stopped at the time of the abnormality has also been proposed. Further, detecting a change of the breakage state (the delete state) of the organic photosensitive layer of an image bearer by irradiating light to predict a life of the image bearer has also been proposed.

It has also been proposed that before an occurrence of poor conveyance, such as a paper jam of a record medium, the image forming apparatus which can perform required processing of maintenance etc.

However, the cause of failure of the image forming apparatus of an electrophotographic system is not only friction wear by usual operation of a photoconductor, an intermediate transfer belt (image bearer), etc. The mixing of toxic substances, such as paper particles from outside, the adhesive power increase accompanied by overchurning of the toner caused by excessive operation, omission of dopant material, etc. may become a cause of failure. A decrease in cleaning and developing ability can gradually reduce the functions of the image forming apparatus. Finally, in any case, trouble is generated in an image bearer's own function, and the image forming apparatus can be in a failed state.

Such failure causes deterioration of image quality. More specifically, an abnormal line image along the direction of rotation, a dull image, an abnormal line image perpendicular to the direction of rotation, a spot-like stain image, a blank image, etc. can occur. Thus, even if there seems to be no problem in the operation of an image forming apparatus itself, the user may notice a problem after continuing operating, when the user views an image. Even in such a case, since repair and redo of image formation are needed, a lot of time can be needed and futility of resources can occur after all.

### SUMMARY

Disclosed herein is an image forming apparatus that effectively reduces maintenance costs and prevents failure of the image forming apparatus during a busy term at the user. In exemplary embodiments the image forming apparatus may include a failure prediction distinction device configured to predict a failure based on an internal state signal, a maintenance time determination device configured to determine a time when maintenance is needed based on the internal state signal, and a maintenance need distinction device configured to distinguish whether or not maintenance is needed based on the result of the failure prediction distinction device at the maintenance time determined by the maintenance time determination device.

An embodiment is also directed to an operating method of an image forming apparatus that effectively reduces maintenance costs and prevents failure of the image forming apparatus during a period of busy use by the user. In exemplary embodiments, the operating method includes a failure prediction distinction step of predicting a failure based on an internal state signal, a maintenance need distinction step of distinguishing whether or not maintenance is needed based on a result from the failure prediction distinction step and the internal state signal, and a maintenance distinction step of distinguishing whether or not a maintenance is performed based on a result from the maintenance need distinction step.

Additional features and advantages will be more fully apparent from the following detailed description of exemplary embodiments, the accompanying drawings and the associated claims.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a cross-sectional diagram illustrating an example of an image forming apparatus according to an exemplary embodiment;

FIG. 2 is a cross-sectional diagram illustrating an example of a part of the image forming apparatus of FIG. 1;

FIG. 3 is a block diagram illustrating an example of a configuration of a controller of the image forming apparatus of FIG. 1;

FIG. 4 is a block diagram mainly illustrating an example of functions of a central processing unit of the image forming apparatus of FIG. 1;

FIG. 5 is a flowchart illustrating an example of an outline of how the maintenance is performed in the image forming apparatus of FIG. 2;

FIG. 6 is a flowchart illustrating an example of process adjustment operation including failure operation in the image forming apparatus of FIG. 2;

FIG. 7 is a graph illustrating an example of the relation between development potential and amount of adhesion toner using the image forming apparatus of FIG. 2;

FIG. 8 is a graph illustrating an example of the relation between the number of printing sheets and an average intensity of light using the image forming apparatus of FIG. 2;

FIG. 9 is a flowchart illustrating an example of judge process of maintenance in the image forming apparatus of FIG. 2;

FIG. 10 is a graph illustrating an example of the relation between the number of printing sheets and parameters P, Q, R, and S used in the image forming apparatus of FIG. 2;

FIG. 11 illustrates an example of a back-office-operations flow of the customer in which the image forming apparatus of FIG. 1 is installed;

FIG. 12 illustrates an example of an operating flow for a maintenance entrepreneur to do a scheduled inspection of the image forming apparatus of FIG. 1;

FIG. 14 is a graph illustrating an example of the relation between the month and the number of printing sheets of the image forming apparatus of FIG. 1;

FIG. 15A illustrates an example of an operation panel of the image forming apparatus of FIG. 1;

FIG. 15B illustrates an example of an operation panel of the image forming apparatus of FIG. 1;

FIG. 15C illustrates an example of an operation panel of the image forming apparatus of FIG. 1;

FIG. 16 is a block diagram illustrating an example of a relation of a two or more input means and a system of the image forming apparatus according to an exemplary embodiment including input means other than an operation panel;

FIG. 17 is a graph illustrating an example of the relation between the month and the number of printing sheets of the image forming apparatus of FIG. 1; and

FIG. 18 is a flowchart illustrating an example of a specification process of a busy term using the image forming apparatus of FIG. 1.

### DETAILED DESCRIPTION OF EXEMPLARY EMBODIMENTS

It will be understood that if an element or layer is referred to as being “on,” “against,” “connected to” or “coupled to” another element or layer, then it can be directly on, against connected or coupled to the other element or layer, or intervening elements or layers may be present. In contrast, if an element is referred to as being “directly on”, “directly connected to” or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

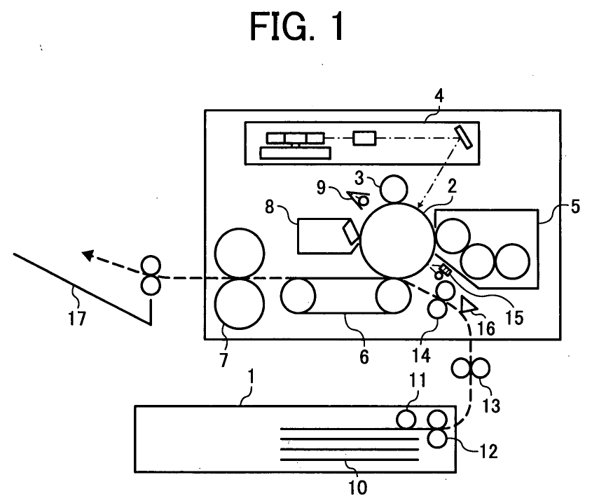

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIG. 1, an example of an image forming apparatus according to exemplary embodiments is explained.

FIG. 1 is a cross-sectional diagram illustrating an example of an image forming apparatus according to an exemplary embodiment. The image forming apparatus includes a photoconductor drum 2, an electrification device 3, a developing device 5, a transferring device 6, a cleaning device 8, a neutralization lamp 9, and an image fixing device 7.

A recording sheet 10 laid in a feeder 1 is conveyed through a recording sheet delivery roller 11 and conveyance rollers 12 and 13 to the position of a registration sensor 16. At this place, a tip of the recording sheet is detected and it is sent to the transferring device 6 via a resist roller 14. With the transferring device 6, a toner image formed in the surface of the photoconductor drum 2 is transferred onto the recording sheet 10. The toner image formed on the recording sheet 10 is fixed in the image fixing device 7, and the recording sheet 10 is discharged onto a recording sheet tray 17.

The photoconductor drum 2 is uniformly charged with the electrification device 3, on this electrified photoconductor drum 2, a modulated light according to an image signal from a writing device 4 is irradiated, and an electrostatic latent image is formed. Toner is supplied with the development device 5 to this electrostatic latent image, and the image to which toner adhered is formed on the photo conductor drum 2. The surface of the photoconductor drum 2 in which this toner image has been formed is observed by a process controlling sensor 15 formed with a light emitting element and a photo acceptance element. A control operation which is mentioned later is performed based on an output of this process controlling sensor 15.

With the transferring device 6, a toner image formed in the surface of the photoconductor drum 2 is transferred onto the recording sheet 10. The cleaning device 8 cleans waste toner on the photoconductor drum 2 after transferring. After that, the electricity on the photoconductor drum 2 is removed with the neutralization lamp 9 if needed. The photoconductor drum 2 is charged again, thus, the image forming process is repeated.

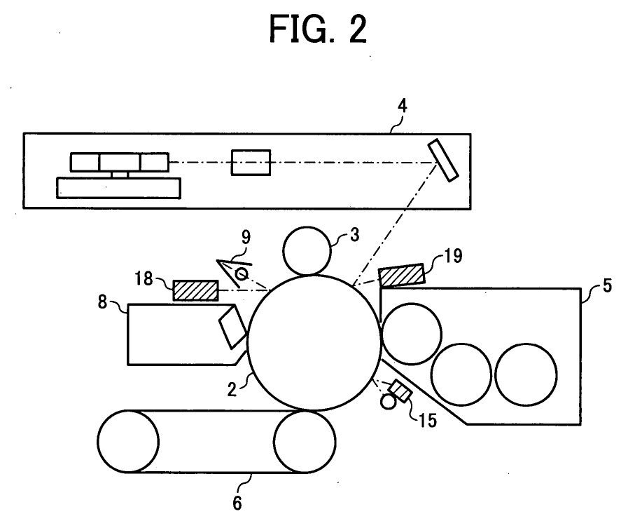

FIG. 2 is a cross-sectional diagram illustrating an example of a part of the image forming apparatus of FIG. 1.

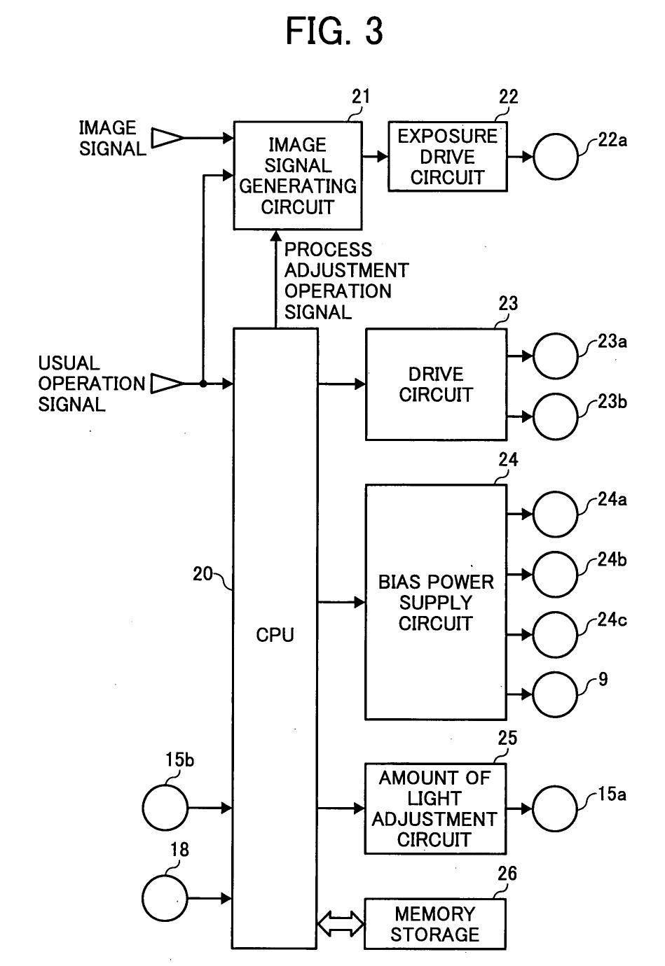

As shown in FIG. 2, the light irradiated onto the photoconductor drum 2 from the neutralization lamp 9 arranged in parallel with the axis of rotation of the photoconductor drum 2 is reflected on the photoconductor drum 2, and the reflected light is taken into a linear catoptric light sensor (CCD) 18 which is arranged at a one plane. Similarly, although FIG. 1 also explains, the process controlling sensor 15 takes in the catoptric light from the photoconductor drum 2 after an exposure and a development. The catoptric light is converted to a control signal which is transmitted into a central processing unit (CPU) 20 as shown in FIG. 3.

FIG. 3 is a block diagram illustrating an example of a configuration of a controller of the image forming apparatus of FIG. 1. As shown in this FIG. 3, the controller of the image forming apparatus of this example has a CPU 20 to which a detection signal from a process controlling photo acceptance element 15b or a neutralization lamp catoptric light sensor (1-dimensional CCD) and a usual operation signal from an input device such as an operation panel are supplied. Further, a drive circuit 23 to control driving of a photo conductor motor 23a and a development drive motor 23b using a control signal from the CPU 20, and a bias power supply circuit 24 to supply a bias voltage to the electrification device 3, the development device 5, the transferring device 6, and the neutralization lamp 9 using a control signal from the CPU 20 are provided in this controller. Moreover, the controller is equipped with a memory storage 26 which stores state logs of the whole image forming apparatus in the past and an amount of light adjustment circuit 25 which performs an amount of light control of a light emitting element 15a of the process controlling sensor.

As shown in FIG. 3, an image signal and a usual operation signal are supplied into the controller of this example from an exterior, and a image signal circuit 21 to which a process adjustment operation signal is supplied from the CPU 20 is provided in the controller. An exposure drive circuit 22 which controls an exposing laser diode 22a based on an output of the image signal circuit 21 is formed. Moreover, the detection signal of the surface of the photoconductor drum 2 from the photo acceptance element 15b of the process controlling sensor and a neutralization lamp reflective sensor 18 is also transmitted into the CPU 20.

A usual operation signal input from an input device such as an operation panel is supplied into the image signal generating circuit 21 besides the image signal read with a (non-illustrated) scanner. The exposure drive circuit 22 operates based on these various signals, and an incoming signal intensity to an exposing laser diode 22a is controlled. Further, the CPU 20 supplies the control signal to the drive circuit 23 which generates the drive signal for driving the photoconductor motor 23a and the development drive motor 23b. Furthermore, the CPU 20 outputs sequentially bias outputs of each image forming process such as an electrification, a development, a transfer, and a neutralization, one by one.

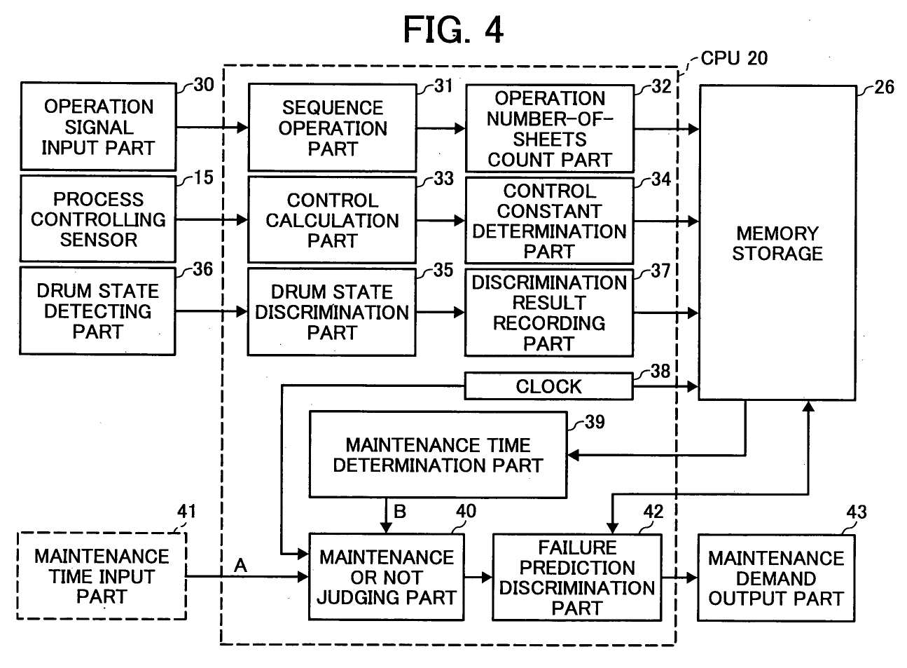

FIG. 4 is a block diagram mainly illustrating an example of functions of a central processing unit of the image forming apparatus of FIG. 1. The CPU 20 includes a sequence operation part 31 which performs a sequence of an image forming operation. This sequence operation part 31 is a portion which performs a control of a start and stop of a drive motor, an ON/OFF control of image forming bias, or a control of an exposure start based on an operation signal from an operation signal input part 30.

The signal from this sequence operation part 31 is sent to an operation number-of-sheets count part 32. The operation number-of-sheets count part 32 is a portion which counts the number-of-sheets conversion that is an operated quantity (time) in which the image forming apparatus has been used. Specifically, whenever it performs image forming operation of one sheet of paper of A4 size, one count is counted up, and an accumulation value is recorded. A3 size is counted as two sheets (two counts) of usual A4 size. This count value is memorized by the memory storage (log managing device) 26 (refer to FIG. 3). In addition, counting operating time of the drive motor instead of counting operation number of sheets may be possible.

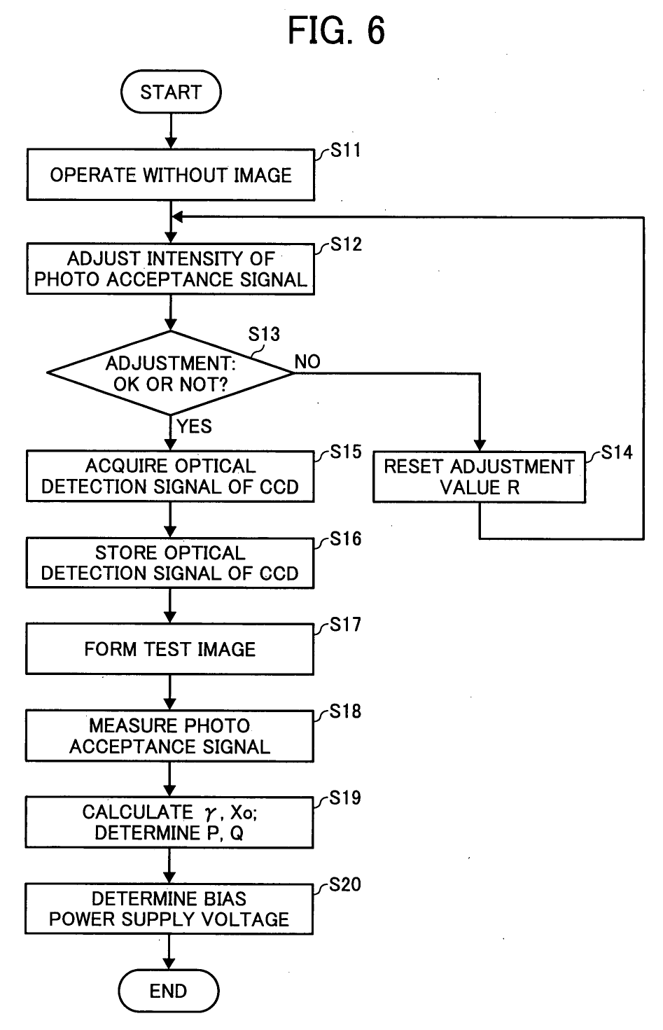

The CPU 20 includes a control calculation part 33. This control calculation part 33 is a portion which attains a gradient γ and a section X₀ that is later mentioned in FIG. 6 based on a signal from the process controlling sensor 15 (refer to FIG. 1 and FIG. 2). Although mentioned later in detail, a predetermined test chart of two or more steps of density is formed on the photoconductor drum 2, and this test chart is read by the process controlling sensor 15. Straight line approximation of plot values of the signal read by the process controlling sensor 15 is carried out, and the gradient y and the section X₀ are attained. The control calculation part 33 also performs sensitivity adjustment of the process controlling sensor 15. This sensitivity adjustment adjusts an amount of light of a light source so that the catoptric light from the surface of the photoconductor drum 2 become fixed intensity with the state where an image is not formed on the photoconductor drum 2. This adjustment value becomes R value mentioned later.

The gradient y and the section X₀ obtained by the control calculation part 33 are sent to a control constant determination part 34. The control constant determination part 34 is a portion which calculates a density compensation value required in order to adjust image density. This density compensation value is a numerical value so that the gradient y and the section X₀ obtained by the control calculation part 33 are close to a characteristic of an original aim, and P and Q value which are mentioned later are equivalent to these. The P and Q value which are density compensation values determined here are stored in the memory storage 26.

The CPU 20 includes a drum state discrimination part 35. This drum state discrimination part 35 is a portion which distinguishes whether the surface of the photoconductor drum 2 has a specular surface or a dirty surface by using a change of the amount of random catoptric light from the photoconductor drum 2 through a drum state detecting part 36. The drum state detecting part 36 includes either the process controlling sensor 15, the neutralization lamp reflective sensor 18 or an exposure catoptric light sensor 19 shown in FIG. 2, and detects drum state by detecting reflective light from the surface of the photoconductor drum 2.

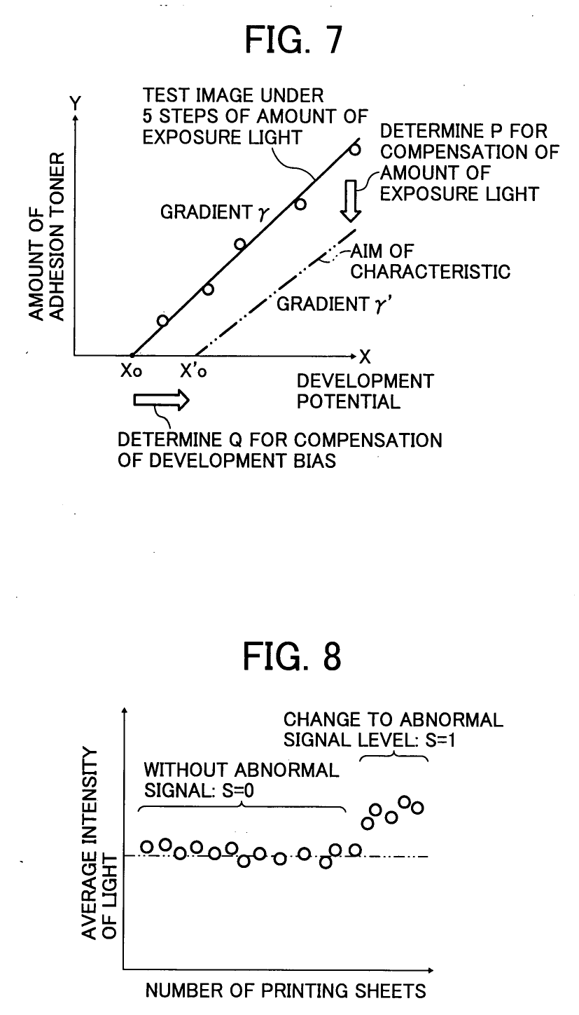

A change of the state of the photoconductor drum 2 distinguished in the drum state discrimination part 35 is sent to a discrimination result recording part 37. The discrimination result of the drum state is memorized by the memory storage 26. The discrimination result is the state discrimination value (S value) which is mentioned later (refer to FIG. 7).

The CPU 20 includes a clock 38. This clock 38 is a portion with the clock function to generate a date and real time. A time of a record date of the data memorized combines with record of data, and is recorded on the memory storage 26 with this clock 38.

The CPU 20 includes a maintenance time determination part 39 which performs failure prediction from a past memorized operation log in the memory storage 26. This maintenance time determination part 39 is a portion which computes automatically a time to perform a maintenance from a past operation log. Concretely, a busy term which has a deviation 2 times more than a standard deviation σ of an average print number of sheets in the past log is detected. A usual term in which a failure prediction is carried out about just before the busy term is set up.

Information about the maintenance time determined in the maintenance time determination part 39 is sent to a maintenance-or-not judging part 40. Time information (for example, a date) is given to the maintenance-or-not judging part 40 from the clock 38. When this time information is in agreement with a maintenance time determined in the above-mentioned maintenance time determination part 39, a need of maintenance is judged.

The maintenance time input part 41 shown by a dotted line of FIG. 4 is a means for a maintenance entrepreneur or maintenance staff to input maintenance time artificially, for example, an operation panel of an image forming apparatus attachments. This maintenance time input part 41 plays the role instead of the maintenance time determination part 39. When this time information from this maintenance time input part 41 is in agreement with a time in the above-mentioned clock 38, a need of maintenance in the maintenance-or-not judging part 40 is judged. In addition, when the maintenance time input part is used, connection of the maintenance time determination part 39 is canceled.

Thus, in the maintenance-or-not judging part 40, the result of a judgment of maintenance-or-not is sent to a failure prediction discrimination part 42. The failure prediction discrimination part 42 calculates information like P, Q, R, and S which are memorized in the memory storage 26 in a fixed procedure. When the operation result compares with a threshold value, it is distinguished whether a possibility of failure is large. This discrimination result is sent to a maintenance demand output part 43 such as a printing device, a time for which failure may occur and a time for a needed maintenance corresponding to the failure are reported to a maintenance entrepreneur or a maintenance staff (maintenance request).

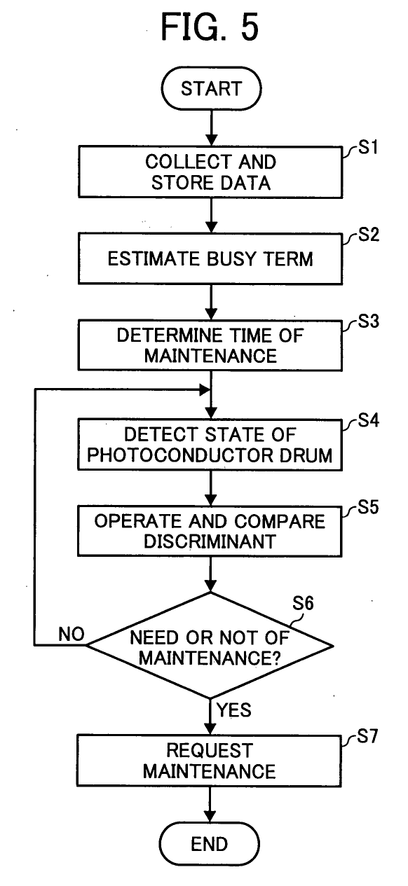

FIG. 5 is a flowchart illustrating an example of an outline of how the maintenance is performed in the image forming apparatus of FIG. 2. Data, such as a state of the photoconductor drum 2 (refer to FIG. 1) and print number of sheets (hour of use), are collected over a long period of time, and are memorized in the memory storage 26 of FIG. 4 (Step S1). Therefore, the history of the past in the image forming apparatus is memorized in the memory storage 26.

A busy term of the image forming apparatus is estimated by using the contents of the memory storage 26 (Step S2). A time (usually term) of the usual use state is also estimated similarly. Presumption of this busyness term is very important when making judgment when to maintain the image forming apparatus. Based on the estimated result of the busy term in this step S2, a time which avoids a busy term and when the image forming apparatus is maintained is determined (Step S3). Here, the maintenance time of the image forming apparatus is determined so that failure may not occur at a busy term.

Next, a state detection of the photoconductor drum 2 is performed (Step S4). The process controlling sensor 15 (refer to FIG. 1 or FIG. 2) is always performing detection of this drum state. Therefore, it is possible to grasp the state of degradation of the drum on real time. Based on the discrimination result of the drum state in Step S4, the operation of the discriminant mentioned later in detail is performed, and this operation result is compared with a predetermined threshold value (Step S5).

Based on the comparing result of the numerical value of the discriminant and a predetermined threshold value of Step S5, judgment whether a possibility of being breaking down is near or judgment of the so-called failure prediction is performed, and need or not of a maintenance is judged (Step S6). When it is judged at this judgment step S6 that a maintenance is required, a maintenance request is made so that the maintenance of the image forming apparatus may be made before the busy term (Step S7). On the other hand, at the judgment step S6, when it is judged that it is not in a state to the extent of maintenance, it returns to Step S4 and state observation of the photoconductor drum 2 is performed successively.

FIG. 6 is a flowchart illustrating an example of process adjustment operation including failure operation in the image forming apparatus of FIG. 2. The flowchart of this FIG. 6 is for explaining in detail operation of the image forming apparatus of this invention shown in the flowchart of FIG. 5. In this flowchart, a control that keeps the toner concentration of the photoconductor constant is explained.

In the image forming apparatus of this example, using a time before and after the usual image formation, a process adjustment operation signal is added to the image signal generating circuit 21 from the CPU 20. At this time, the image signal generating circuit 21 is first set as a state of without image (Step S11). In the state where there is no image on the photoconductor drum 2 surface, the CPU 20 adjusts amount of luminescence of the laser diode for exposure so that a photo acceptance signal from the surface of the photoconductor drum 2 may become a predetermined value (Step S12). The adjustment of amount of luminescence in Step S12 is equivalent to calibration for measuring toner image concentration with sufficient accuracy, without being influenced by a variation in light emitting and photo acceptance elements, a variation per hour, and a variation per hour of a surface state of the photoconductor drum 2. In the adjustment process of this amount of luminescence, an adjustment value R which is an internal preset value of amount of photo acceptance is set up. Based on this adjustment value R, amount of luminescence in the writing device 4 may be controlled.

Next, it is judged whether this adjustment value R is in agreement with the value set up beforehand, and whether adjustment of amount luminescence to initial preset value is established or not is judged (Step S13). When it judges that the adjustment value R is not in agreement with the initial preset value, the adjustment value R is reset up (Step S14). It returns to Step S12 and amount of luminescence of the laser diode for exposure is adjusted.

In order to observe a surface state of the photoconductor drum 2 when the adjustment value R is in agreement with the value set up beforehand, an optical detection signal is acquired by the neutralization lamp reflective sensor (CCD) 18 installed around the photoconductor drum 2 (Step S15). This result is stored to memory storage 26 (Step S16). In addition, the exposure catoptric light sensor 19 can be used instead of the neutralization lamp reflective sensor 18 here, and the surface state of the photoconductor drum 2 can also be detected.

Next, test image forming operation is performed (Step S17). This test image forming operation is operation which measures the toner image concentration on the photoconductor drum 2 surface, outputting a specific test image automatically and detecting this test image optically by the process controlling sensor 15. Here, for example, a test image in which a pattern of a uniform concentration of different five steps of exposure is used. The specific value beforehand decided as the electrification bias at this time and development bias is used. At this time, predetermined specific values as an electrification bias and a development bias are used.

After test image forming operation of Step S17, a photo acceptance signal is measured (Step S18). Measurement of this photo acceptance signal is operation of detecting a catoptric light from the surface of the photoconductor drum 2 as an optical detection signal. Although the composition of this detection sensor may be provided from a light emitting element and a photo acceptance element of exclusive use, it is also possible to make the process controlling sensor 15, the neutralization lamp reflective sensor 18, or the exposure catoptric light sensor 19 shown in FIG. 2 serve a double purpose. However, although the process controlling sensor 15 detects the catoptric light of the specific portion on the photoconductor drum 2, the neutralization lamp reflective sensor 18 and the exposure catoptric light sensor 19 are 1-dimensional CCD sensors arranged in parallel with the axis of rotation of the photoconductor drum 2.

As mentioned above the process controlling sensor 15, the neutralization lamp reflective sensor 18, or the exposure catoptric light sensor 19 may have optic angle so that it may accept diffused reflection light, may accept mirror reflection light, or may accept both of the reflection lights. Usually, the surface of a photoconductor drum is very flat and smooth, and does not generate diffused reflection light. In order to find out the adhesion thing or fine target crack in the image forming apparatus of this example, it is needed to catch a strong diffused reflection light which a structure with the unevenness by the crack or an adhesion thing emits.

FIG. 7 is a graph illustrating an example of the relation between development potential and amount of adhesion toner using the image forming apparatus of FIG. 2. Measurement operation of the photo acceptance signal is explained in detail based on FIG. 7. About five steps of amount of exposure light, a predetermined electrification bias and a development bias are set up and development potential is determined. Thus, about five steps of amount of exposure light which are set up and measured, the amount of toner adhesion was measured from the catoptric light of the photoconductor drum. FIG. 7 shows the result.

In FIG. 7, the points corresponding to five steps of test images are plotted. They are shown as circles. They are almost on a straight line. When a gradient of this straight line is set to y and this straight line sets to X₀ as the section which crosses the X-axis, it may become like expression (1). This straight line is the amount of adhesion toner to the development potential which has been carried out linearisation from the photo acceptance signal of the five points.

(Expression (1))
y(x)=γ(x−X₀) (1)

Since various factor phenomena which result in failure occur in the image forming apparatus like this example as shown in FIG. 7, the state of the surface of the photoconductor drum 2 may change, and the amount of toner adhesion which should not change under the same operating condition may be changed. For example, according to the change factor mentioned above, when the gradient γ and the section X₀ have different characteristic from an aim, the gradient γ may be adjusted to a characteristic of aim (a gradient γ′: a chain double-dashed line of FIG. 7) by changing a parameter P for compensation of amount of exposure light. Moreover, since the section X₀ is the development potential in which toner begins to adhere, the section X₀ is adjusted to a characteristic of aim (a section X₀′) by changing a development bias compensation parameter Q.

In FIG. 6, after the photo acceptance signal measurement of Step S18 is completed, the gradient γ and the section X₀ as shown in the above-mentioned FIG. 7 are computed, and the internal state variables P and Q are determined based on the results of the calculation (Step S19). Based on these parameters P and Q, a bias power supply voltage is determined (Step S20). A line close to the characteristic of aim (a chain double-dashed line of FIG. 7) may be acquired. Process adjustment operation which includes failure detection mentioned above is completed.

FIG. 8 is a graph illustrating an example of the relation between the number of printing sheets and an average intensity of light using the image forming apparatus of FIG. 2. An S value which shows the print number of sheets and a surface state of the photoconductor drum 2 when carrying out continuous printing using the image forming apparatus of this example is explained based on FIG. 8. For example, an average output signal level (optical intensity) from the photo acceptance unit (CCD) of the process controlling sensor is recorded one by one, whenever the print number of sheets progresses. As shown in FIG. 8, light intensity of almost fixed value is maintained to predetermined print number of sheets. If print number of sheets exceeds predetermined number of sheets, the light intensity may change to an unusual level. The surface status value S which is maintaining the state where the light intensity is almost fixed is set to “0.” When the light intensity becomes high, that is, the surface status value S when an average output level turns into an unusual level is set to “1.” It is thought that the rise of this S value originates in a crack and the adhesion thing of a part or the whole on the photoconductor drum 2 surface with an increase in print number of sheets (progress of time). For this reason, in a conventional apparatus, it has the surface status value S is used for judging a replace time of the photoconductor drum. However, the rise of the average level of the catoptric light from the photoconductor drum 2 is detected, and when the apparatus is constituted so that a maintenance demand may be reported immediately, there is a possibility that false reports may occur frequently. Therefore, also in such the case, it is required to perform discrimination of failure, and prediction whether a maintenance is demanded.

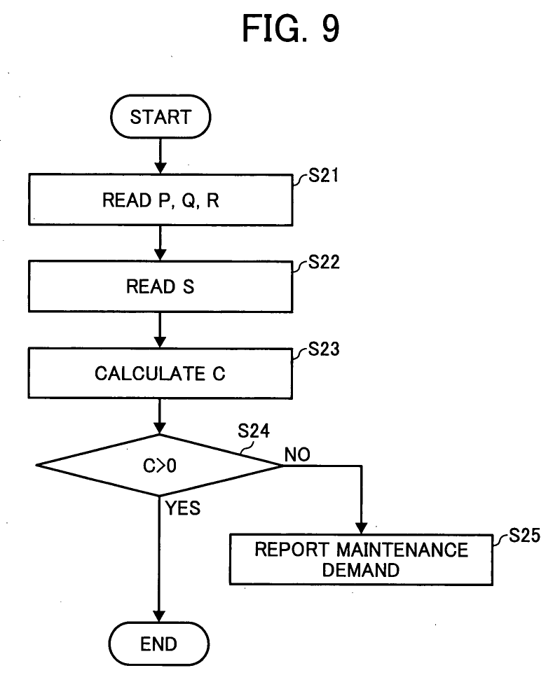

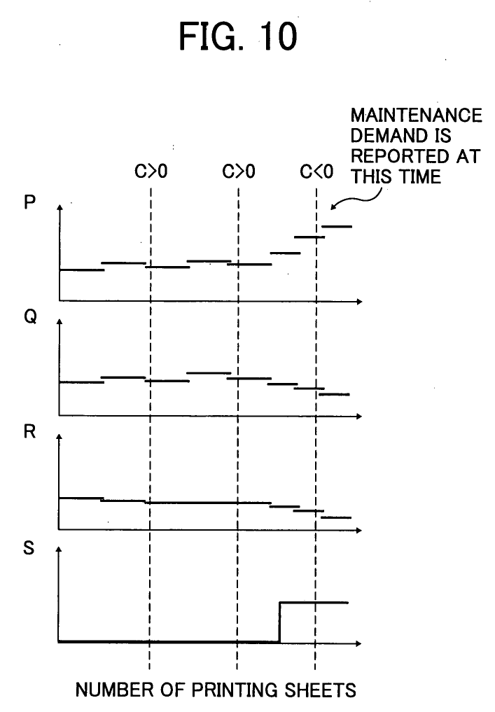

In this example, an integrated judgment value C not only including the surface status value S but R, P, and Q values mentioned above are calculated, and failure prediction with this judgment value C is performed, so that whether maintenance is made or not may be judged. FIG. 9 is a flowchart illustrating an example of judge process of maintenance in the image forming apparatus of FIG. 2. FIG. 10 is a graph illustrating an example of the relation between the number of printing sheets and parameters P, Q, R, and S used in the image forming apparatus of FIG. 2.

The CPU 20 reads a light exposure compensation parameter P, a development bias compensation parameter Q, and an adjustment value R acquired by an operation of five test images shown in FIG. 6 and FIG. 7 from the memory storage 26 of FIG. 3 (Step S21). The surface status value S explained in FIG. 8 is read from the memory storage 26 (Step S22). Based on these values, a state index value C is calculated with expression (2) (Step S23).

(Expression (2))
C=f(P, Q, R, S)=a P+b Q+c R+d S+C₀ (2)

Where a−d is a constant (it may become a negative number), and is the value which can be arbitrarily set up as a weighted value of P−S. The C₀ is an initial value and expresses a state index value in case P, Q, R, and S are ‘0’. Here, it is assumed that C₀=0 temporarily.

It is judged whether the state index value C calculated with expression (2) in Step S23 is larger than ‘0’ (Step S24). The processing is ended without performing a maintenance demand, if C>0. If C<0, it is judged that there is possibility of failure in the near future, and a maintenance demand is reported (Step S25).

FIG. 10 shows how P value (amount of exposure light compensation parameter), Q value (development bias compensation parameter), R value (luminescence intensity adjustment value), and S value (surface status value) may change to number of printing sheets. Although predetermined variation is produced in P value, Q value, and R value before print number of sheets reaches predetermined number of sheets, it may not change extremely. In such the case, the state index value C may be set to “C>0” based on expression (2), and it may be judged that it is not in the state of reporting a maintenance demand. However, if print number of sheets increases and exceeds predetermined number of sheets, the change of P, Q, and R value become large, and S value rises in the shape of stairs. In such the case, the state index value C may be set to “C<0” based on expression (2). This state is in the surface state of the drum which failure tends to generate. It means that it is necessary to maintain.

As mentioned above, since a development state can change if the surface state of the photoconductor drum 2 changes, all of P, Q, and R can change. In the image forming apparatus of this example, the possibility of failure generating is predicted based on four parameters containing all of these parameters, and a maintenance demand is judged. Therefore, there are few false reports and the image forming apparatus can perform surer failure generating prediction and a maintenance demand. Here, although the formula f (P, Q, R, S) is calculated using a linear combination equation of P, Q, R, and S, the state index value may be calculated with other expressions. Coefficients a, b, c, and d are the values which can be freely set up according to the state of the image forming apparatus as weighted parameters.

As for the inner state variables P, Q, R, and S, it is desirable to collect much data at the time of normal and the time of failure beforehand, and to enable it to judge normalcy or failure on a statistics. When a failure is judged, an inside is checked irrespective of whether the unusual image has actually occurred, and the image forming apparatus can be repaired before failure actually takes place.

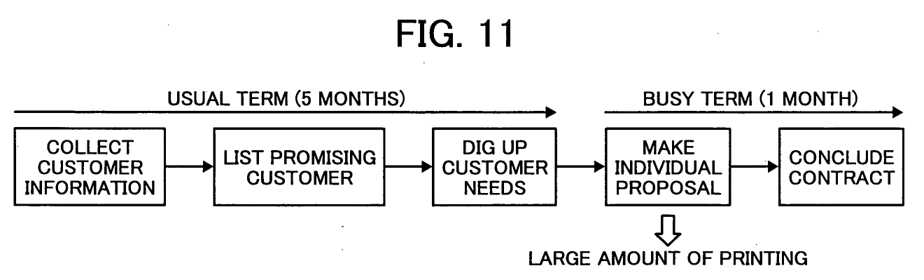

FIG. 11 illustrates an example of a back-office-operations flow of the customer in which the image forming apparatus of FIG. 1 is installed. The example shown in FIG. 11 shows the operating flow of the office of the company which performs comparatively big-ticket goods sale for individuals of life insurance, a car dealer, etc. In such a company, it does not wait for a customer but positively digs up a potential customer usually. After finding a customer, the proposal which matched every customer is performed and, a contract is usually concluded.

In these types of industry, the main operating activities are performed in a cycle of half a year, and a print of a proposal document etc. tends to increase rapidly just before conclusion. Not only in this example but in each type of industry, a main operating cycle may exist and a print may increase rapidly at a certain specific time. This is the time so-called on-season term which is busy term. If failure of an image forming apparatus occur in this busy term, of course, the bad influence on business can become unfathomable.

In the operating flow shown in FIG. 11, it has a cycle of half a year, and five months as a usually term and one month as the busy term. Usually, in a term of the five months, information gathering of a customer is performed first and promising customers are listed based on the result. Analysis of what those promising customers desire is performed. This is called digging up customers. After analysis of customer information, an individual proposal document is drawn up. A contract with a customer is concluded based on this individual proposal document. A lot of print is generated in this stage. That is, the image forming apparatus is in a busy term.

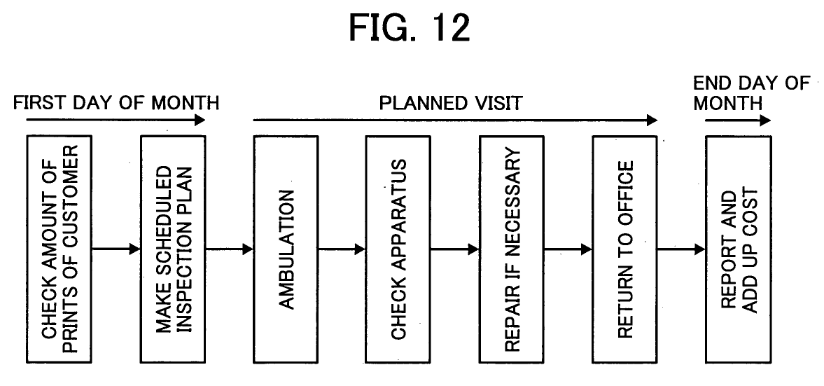

FIG. 12 illustrates an example of an operating flow for a maintenance entrepreneur to do a scheduled inspection of the image forming apparatus of FIG. 1. Generally, the scheduled inspection work of an image forming apparatus is done according to the amount of the apparatus used. In recent years, the amount values used can be transmitted, such as a print number-of-sheets counter, to a maintenance commissioned company using a telephone line or a network. That is, a maintenance management system by which those who perform maintenance business can know a busy condition of a customer's image forming apparatus etc. at remoteness is built.

It can be known whether the amount of prints has reached the required value of a scheduled inspection remotely even if not visiting a customer. Thereby, personnel expenses and move expense accompanying a visit can be reduced. However, while a customer is in a busy term and the amount of prints is increasing, visiting to know whether a scheduled inspection is required can become a visit which is not welcomed by the customer. Although the case where a planned visit is carried out immediately after the busy term passed increases, it is not helpful to prevent failure in the busy term.

Then, in order to prevent failure occurring at a busy term, it is considered that a check visit before a busy term may surely be performed. Although this is effective in failure prevention of a busy term, it may also become carrying out an unnecessary check visit. Usually, the personnel expenses and move expense concerning a visit are comparatively big-ticket of maintenance cost in the image forming apparatus. As for such an unnecessary visit, it is desirable for large increase of a maintenance cost to be caused and to lessen it as much as possible.

On the other hand, when urgent check is performed by a sudden failure irrespective of a busy term or a usually term, a high skilled maintenance staff who can fix by tracing the cause of failure in a short time is needed. Since the technical skill is high compared with the maintenance staff who visits a customer by general planned management of maintenance, the expense also becomes high. Therefore, there is also a request of minimizing the expense burden concerning these maintenance staff.

In this example, about the user who can specify a busy term, whether a maintenance of the image forming apparatus is required about just before a busy term can be judged using above-mentioned failure prediction distinction technology, and it can be judged whether check or repair is performed according to the judgment. Since it is not necessary to dispatch the high skilled maintenance staff vainly, increase of a careless maintenance cost is prevented. Since data collection of the parameter used for failure prediction distinction is usually carried out during operation of a usual term and it can be utilized, it is not necessary to carry out special test operation.

Here, it is appropriate to think the about just before the busy term as follows according to the length of the operating period which contains 1 time of a busy term. A month before the busy term can be considered as about just before the busy term on a unit which has a cycle of busy term of a year or half a year. A 10 days before the busy term can be considered as about just before the busy term on a unit which has a cycle of busy term of a month. A 2 days before the busy term can be considered as about just before the busy term on a unit which has a cycle of busy term of a week. A 6 hours before the busy term can be considered as about just before the busy term on a unit which has a cycle of busy term of a day.

The example of FIG. 12 shows a scheduled inspection operating flow for one month of a maintenance staff. The amount of prints of the image forming apparatus currently sent through the network on the first day of a month from the customer is checked. A scheduled inspection plan is drawn up, the day of a planned visit is decided, and the planned visit is performed. In the case of a planned visit, after visiting a customer and checking the apparatus, if there is necessity, it can be repaired. A report is drawn up after the visit and return back to the office. On the end of the month, adding up the cost concerning check, and the business for one month is ended.

FIG. 13 illustrates an example of an operating flow of for a maintenance entrepreneur to do a urgent inspection of the image forming apparatus of FIG. 1. An work which a maintenance staff performs also in this case at the time of a visit is not different from the work shown in FIG. 12. However, since failure has already occurred in a customer in many cases overwhelmingly, it must not return to the office without repairing in the case where a urgent contact is made. Of course, unlike the example of FIG. 12, there is also no scheduled inspection plan document. Therefore, it is necessary to dispatch the high skilled maintenance staff to the customer.

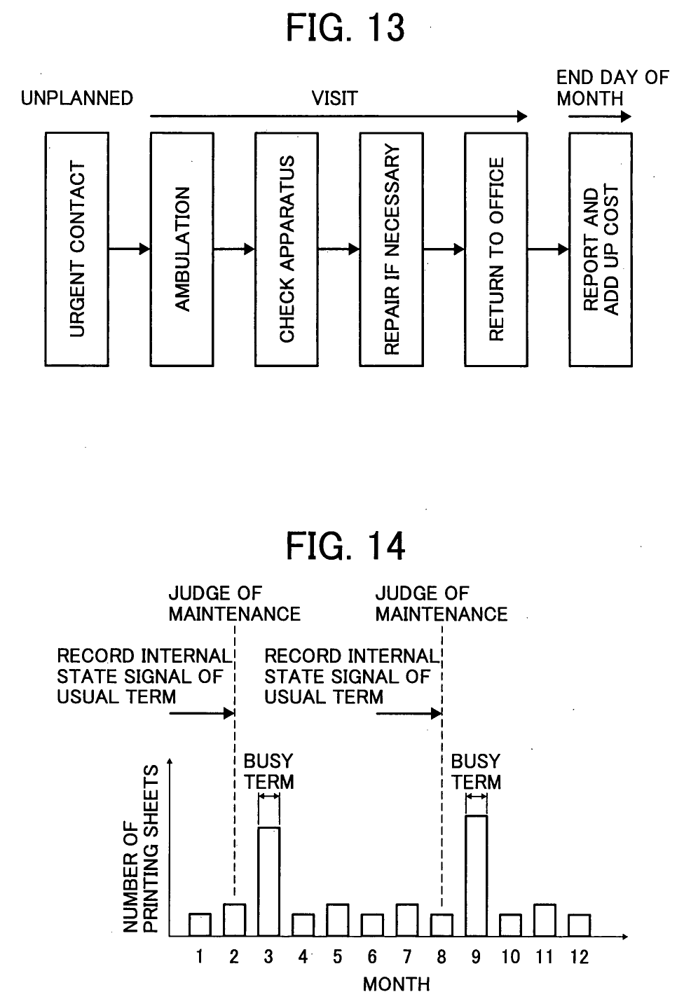

FIG. 14 is a graph illustrating an example of the relation between the month and the number of printing sheets of the image forming apparatus of FIG. 1. FIG. 14 also explains the time of maintenance judgment in case there is a 1-time busy term in half a year. In this figure, for example, it is assumed that March which is an accounting period in a company, and September which is a middle settlement-of-accounts term become a busy term. Print number of sheets usually increases by 3 to 4 times at this busy term compared with a usual term. Then, the state signal inside the image forming apparatus is recorded in February and August about one month before a busy term starts. A maintenance staff can judge that it is better whether to go to check having seen the record of this internal state signal.

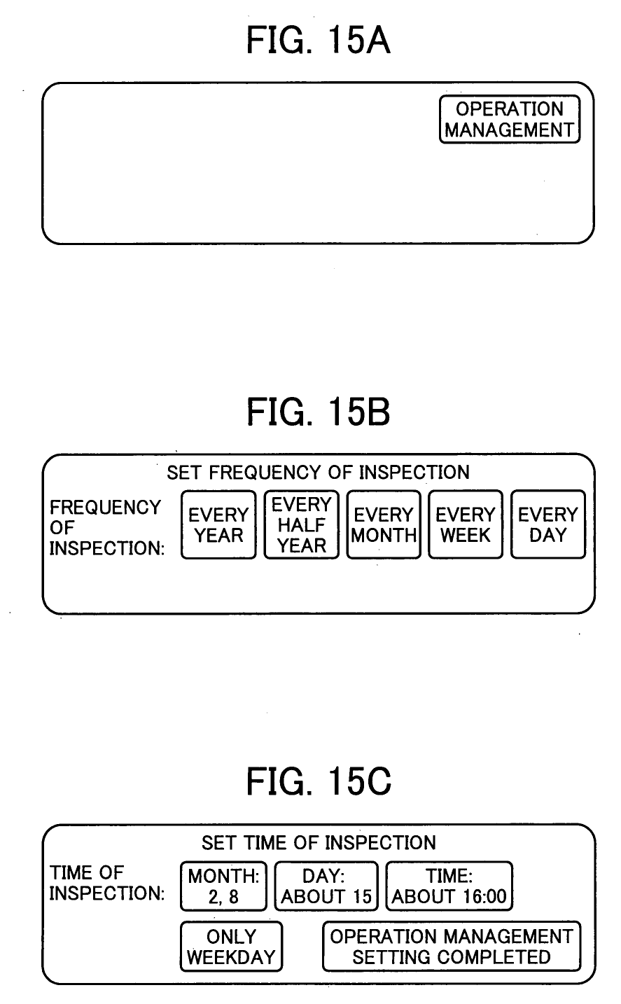

FIG. 15A, FIG. 15B, and FIG. 15C show an operation panel as an input means to specify the time to judge whether it maintains or not. This operation panel is a panel with which the image forming apparatus is equipped, and is usually formed by a touch panel. According to the cycle and operating convenience in a busy term, a maintenance interval and its time can be specified using this operation panel.

FIG. 15A is a screen at the beginning, and if “operation management” is touched, the screen of FIG. 15B will appear. In the screen of this FIG. 15B, a frequency of a maintenance is input. This is set up according to a busy condition of the image forming apparatus in a customer.

If inspection time is every half a year, “EVERY HALF YEAR” of FIG. 15B is input and the operation panel becomes the input screen of FIG. 15C. In the screen of FIG. 15C, the inspection timing is input as “MONTH: 2, 8”, and a day of visit is input as “DAY: ABOUT 15”. Further, a time of visit is input as “TIME: ABOUT 16:00”, and a condition of the day of visit is input as “ONLY WEEKDAY”. Pushing “OPERATION MANAGEMENT SETTING COMPLETED” returns back to the beginning screen of FIG. 15A.

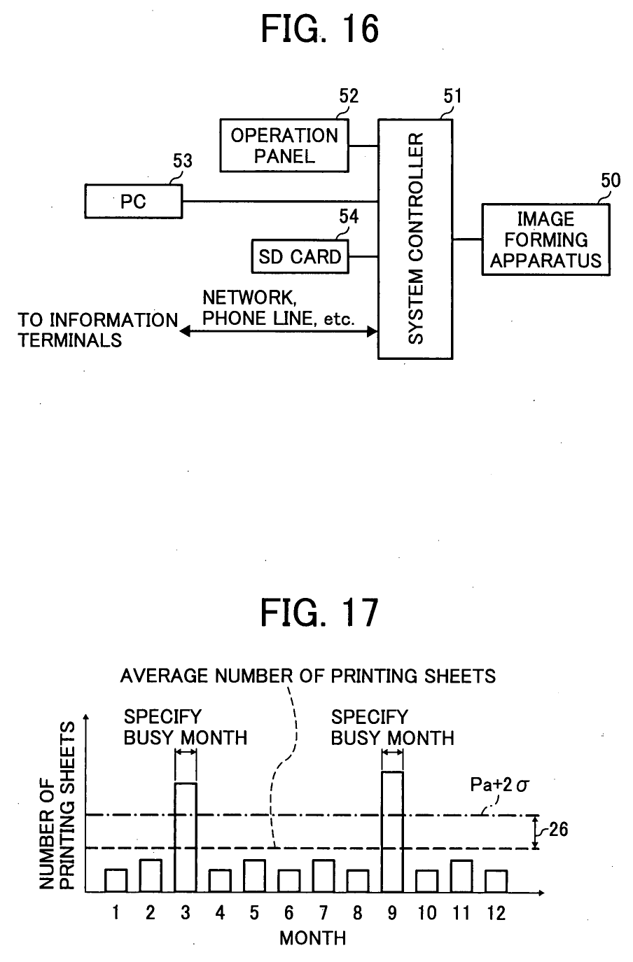

FIG. 16 is a block diagram illustrating an example of a relation of a two or more input means and a system of the image forming apparatus according to an exemplary embodiment including input means other than an operation panel. The image forming apparatus 50 is connected to a system controller 51 which controls the whole system. In addition to an operation panel 52 of the image forming apparatus, which is connected to the system controller 51, an information storage device (memory) like an SD card 54 or a maintenance staffs personal computer (PC) 53 can also be connected with the system controller 51. Moreover, the input of these information can also be carried out between the system controllers 51 of the image forming apparatus 50 and maintenance entrepreneur information terminals using an electric communication line.

Therefore, the input of the maintenance time shown in FIG. 16 can be input into the system controller 51 from not only the operation panel but the maintenance staff's PC 53 or the SD card 54 which the maintenance staff brought. In addition, this input can be carried out by a maintenance entrepreneur or a maintenance staff remotely using means of communication, such as a network or a telephone line.

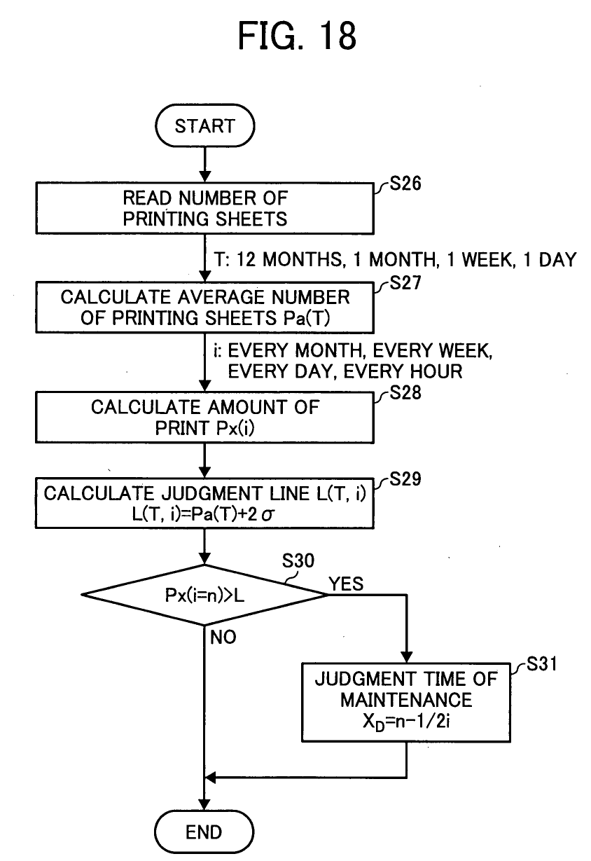

Next, how to specify a busy term is explained based on FIG. 17 and FIG. 18. A user does not perform specification of this busy term by an input means, but the image forming apparatus itself deduces a busy term from a past operation history, and specifies the time to perform failure prediction distinction. Thereby, an input work is reduced.

FIG. 17 is a graph illustrating an example of the relation between the month and the number of printing sheets of the image forming apparatus of FIG. 1. For example, in the case of a print history as shown in FIG. 17, the number Pa of average print sheets in month-long (12-month average) is calculated. On the other hand, since the monthly amount Px (one month) of prints is known, standard deviation σ is computable from Px and Pa. The twice value of this standard deviation σ is added to the number Pa, and a judgment line L with a required maintenance (12 months, one month) is determined. Comparing with this standard, March and September have the amount of prints beyond the judgment line L, and are specified as the busy month.

FIG. 18 is a flowchart illustrating an example of a specification process of a busy term using the image forming apparatus of FIG. 1. The print number of sheets memorized in the memory storage is read (Step S26). Although a period T of this read-out is as various as one year (12 months), one month, one week, and one day, what period T of an average is taken depends for a frequency of busy terms.

After Step S26 of reading the print number of sheets record, the average print number of sheets of the read period can be calculated. In the example of FIG. 17, the number Pa of average print sheets for 12 months is calculated (Step S27). For example, the print number of sheets Px(i) in the specific period i is computed (Step S28). Although period i is every month in FIG. 17, every week, every day, or every hour can also be selected. How a busyness term appears is dependent on a busy condition of the image forming apparatus.

Standard deviation a is calculated from the number Pa of average print sheets and the print number of sheets Px in the period i, a judgment line L(i)=Pa +2σ of whether to need a maintenance based on this sigma is calculated (Step S29).

After the Step S29 of deciding the judgment line L (i), it will be judged whether the print number of sheets Px (i) of the period i (here one month) is over the judgment line L (Step S30). In this judgment step S30, when the print number of sheets Px (i=n) (n is March and September in the example of FIG. 17) is over the judgment line L in the specific period i, a maintenance judgment time X_{D} is set with a shift only the period of the half of period i (one month) before from the period n (Step S31). In the example of FIG. 17, the middle in February and the middle in August can correspond at the maintenance judgment time X_{D}.

The processing is ended without setting up the maintenance judging time when it is judged that the print number of sheets Px(i) is not over the judgment line L (this correspond to the period of ten months: October-February, and April-August in FIG. 17) in the judgment step S30.

When a busy term is not found by an algorithm which was mentioned above, applying the maintenance judging time which is input from an operation panel etc. can be carried out using a default setup. Business planning of a user or a maintenance entrepreneur can be effectively performed by constituting so that the specific result of a such busy term may be reported to a user, a maintenance entrepreneur, etc.

Although the algorithm for specifying the busy term mentioned above is an algorithm usually carried in the inside of the image forming apparatus, in order to specify a busyness term, calculating from print number-of-sheets record of the past which the maintenance entrepreneur took out remotely using the same algorithm can be carried out. The equipment composition which a maintenance entrepreneur takes out remotely to his own information terminal is shown in FIG. 16. Moreover, even if such an algorithm is not used, a maintenance entrepreneur is able to make a graph of logs, such as print number of sheets memorized by the image forming apparatus, and to judge maintenance time visually.

In the image forming apparatus of an example, since it can input the maintenance judgment time from the memory card equipped with the image forming apparatus, the operation panel of the image-forming-apparatus, or the PC connected to the image forming apparatus, a general user can also judge the necessity for a maintenance easily.

This invention is not limited to the above-mentioned examples. It is clear that the form of each above-mentioned example may be suitably changed within the limits of this invention. Also, the number of components, a position, form, etc. are not limited to the form of each above-mentioned example, when carrying out this invention, they may have a suitable number, a position, form, etc.

Numerous additional modifications and variations are possible in light of the above teachings. It is therefore to be understood that within the scope of the appended claims, the disclosure of this patent specification may be practiced otherwise than as specifically described herein.

This patent specification is based on Japanese patent applications, No. JPAP2006-128498 filed on May 2, 2006 in the Japan Patent Office, the entire contents of which are incorporated by reference herein.

What is claimed:

1. An image forming apparatus, comprising:
a failure prediction distinction element configured to predict a failure based on an internal state signal,
a maintenance time determination element configured to determine a time when maintenance is needed based on the internal state signal, and
a maintenance need distinction element configured to distinguish whether maintenance is needed based on a result from the failure prediction distinction device at the maintenance time determined by the maintenance time determination element.

2. An image forming apparatus, comprising:
a failure prediction distinction element configured to predict a failure based on an internal state signal,
a clock configured to generate date information,
a maintenance time input element configured to pre-specify a time when a need of maintenance is distinguished, and
a maintenance need distinction element configured to distinguish whether maintenance is needed based on a result from the failure prediction distinction element when the maintenance time input by the maintenance time input element coincides with the date information generated by the clock.

3. The image forming apparatus of claim 1, comprising:
a log keeper configured to keep an operation log of the image forming apparatus, and
a clock configured to generate date information,
wherein the maintenance time determination element reads the log and presumes a busy term of the image forming apparatus and determines a time before the busy term as a time when a need for maintenance is distinguished, and the maintenance need distinction element distinguishes whether maintenance is needed when the maintenance time determined by the maintenance time determination element coincides with the date information generated by the clock.

4. An operating method of an image forming apparatus which distinguishes a busy and a slow term of operation, comprising:
predicting a failure based on an internal state signal,
determining whether maintenance is needed based on a result from the step of predicting a failure based on an internal state signal and the internal state signal, and
determining whether maintenance is performed based on a result from the step of determining whether maintenance is needed.

5. The operating method of claim 4, comprising:
specifying a time for performing the step of determining whether maintenance is performed.

6. The operating method of claim 4, comprising:
keeping an operation log of the image forming apparatus,
presuming a busy term of the image forming apparatus, and
determining a time before the busy term as a time when a need for maintenance is distinguished.
